(19) United States
(12) Patent Application Publication
(10) Pub. No.: US 2007/0166685 A1
(43) Pub. Date: Jul. 19, 2007

(54) Automated skills assessment

(76) Inventors: David Gilbert, Parker, CO (US); Bruce Sharpe, Aurora, CO (US); Daniel S. Barrett, Aurora, CO (US)

Correspondence Address: MERCHANT & GOULD PC, P.O. BOX 2903, MINNEAPOLIS, MN, 55402-0903, US

(21) Appl. No.: 11/317,369

(22) Filed: Dec. 22, 2005

(51) Int. Cl. G09B 7/00

(52) U.S. Cl. 434/323

(57) ABSTRACT

An approach for automated skills assessment over a network is provided herein. Test subjects request an evaluation session via a phone call, email exchange, instant message exchange, or facsimile transmission. An information capture system facilitates the evaluation session forwarding prompts to the test subject and forwarding responses to a processing system. Upon completion, the responses are stored along with the prompts and assigned a unique identifier. Assessors including humans and computer applications access the network through a data transfer system and receive the stored evaluation session. Assessments for each evaluation session are stored by the processing system for subsequent delivery to subscribers.

### BACKGROUND

In a business environment of ever increasing complexity, competition, and commoditization, customer experience becomes paramount for the world's leading enterprises. And as business models increase in sophistication, companies pay more attention to managing the customer experience. Globalization, consolidation, and increasingly complex service offerings make customer management programs more important than ever before.

Worldwide, cost-saving initiatives, mergers, and acquisitions provide many new customer-facing opportunities for banks, brokerage firms, insurance companies and real estate organizations, and the like. Such companies can achieve even greater efficiencies by maintaining consistent service across disparate internal entities. This consistency enables customers to transition easily to new brands and new product offerings without experiencing any of the doubt or hesitancy that often accompanies new providers.

Multi-channel customer service representatives (CSRs) maintain the high service quality offered by in-store employees using phone, email, fax, chat, and other Web communications, including Voice over Internet Protocol (VoIP). While customer service employees may be located in many locations of the world, it is a challenging task to evaluate a candidate's skills in as many locations.

Skills assessment is not limited to customer service employees. Educational institutions and non-governmental organizations (NGO's) are just a couple of examples of organizations that have a need for efficient, remote, and accurate assessment of a candidate's skills in a variety of areas.

It is with respect to these and other considerations that the present invention has been made.

### SUMMARY

Embodiments are generally related to automated skills assessment of test subjects over a network. More particularly, the embodiments involve test subjects requesting an evaluation session using a phone call, an electronic mail exchange, an instant message exchange, a facsimile transmission, and the like. Prompts for evaluating are provided to the test subject and responses provided to a processing system. The responses may be stored and assigned a unique identifier. Assessors including humans and computer applications may access the network and receive the stored evaluation session. Assessments for each evaluation session are stored for subsequent delivery to subscribers.

Individual components of the system as well as the test subjects and the assessors may access the automated skills assessment system through a variety of communication networks.

For example, embodiments are applicable to language skills assessment of labor pool candidates in different countries. In an embodiment, candidates may call a local number for an evaluation session. An automated call distribution system may facilitate exchange of prompts and responses between the candidate and automated processing system. The responses may be recorded and provided upon request to an assessor at a different location. Assessments may also be stored by the processing system for subsequent delivery to an employer.

In accordance with another embodiment, candidates may be contacted and prompted to repeat the evaluation or take a higher level of evaluation based on the assessment.

Various embodiments may be implemented as a computer process, a computing system or as an article of manufacture such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process.

These and various other features as well as advantages, which characterize the present invention, will be apparent from a reading of the following detailed description and a review of the associated drawings.

### DESCRIPTION OF DRAWINGS

FIG. 1 is a conceptual diagram illustrating major blocks of an automated skills assessment system in accordance with an embodiment.

FIG. 2 shows an example automated skills assessment system and interactions of its components.

FIG. 3 shows an In-Country Local DID Dialing system, which is an example of a local communications system component of an automated skills assessment system.

FIG. 4 illustrates an assessment system that may be part of the automated skills assessment system of FIG. 1.

FIG. 5 illustrates an example information capture system and a data transfer system as part of an automated skills assessment system for testing language skills over the phone.

FIG. 6 illustrates an example processing system that interacts with the information capture system shown in FIG. 5.

FIG. 7 is a flow diagram illustrating a process for automated skills assessment in accordance with an embodiment.

### DETAILED DESCRIPTION

Embodiments will now be described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

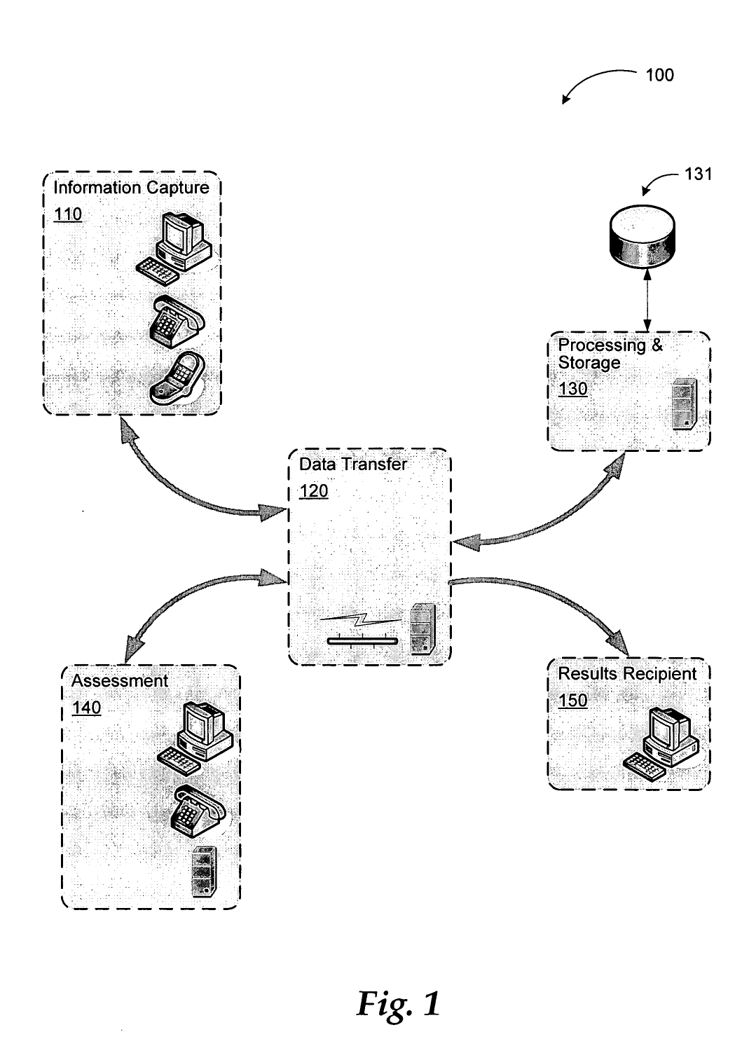

In general, the embodiments relate to automated skills assessment of test subjects over a network. Referring to FIG. 1, major functional blocks of an example automated skills assessment system (100) according one embodiment are shown.

Automated skills assessment system 100 includes information capture block 110, data transfer block 120, processing and storage block 130, assessment block 140, and result recipient 150. Each of the major functional blocks may perform a variety of actions associated with assessing skills of a test subject. The actions may be performed by one or more computing devices individually or in a distributed manner where the computing devices communicate over one or more networks. Other devices such as telephones, telephone network devices, and the like may also be part of the skills assessment system. All these devices are well known in the art and need not be discussed at length here.

Computing device(s) performing the actions may contain communications connection(s) for communicating with each other and other devices. The communications connection(s) is/are an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media.

The computing devices typically include at least some form of computer readable media. Computer readable media can be any available media that can be accessed by a processing unit. By way of example, and not limitation, computer readable media may comprise computer storage media and communication media. Combinations of any of the above should also be included within the scope of computer readable media.

As mentioned above, the computing devices may operate in a networked environment using logical connections to one or more remote computers (not shown). The remote computer may be a personal computer, a server computer system, a router, a network PC, a peer device or other common network node, and typically includes many or all of the elements relative to the computer devices. The logical connections between the computer devices may include a local area network (LAN) or a wide area network (WAN), but may also include other networks. Such networking environments are commonplace in offices, enterprise-wide computer networks, intranets, and the Internet.

By way of example, and not limitation, a remote application program may reside on memory device connected to the remote computer system. It will be appreciated that the network connections explained are exemplary and other means of establishing a communications link between the computers may be used.

With the above described computing environment in mind, logical operations of the various exemplary embodiments described below in connection with an automated skills assessment process may be implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations making up the embodiments of the exemplary embodiments described herein are referred to variously as operations, structural devices, acts or modules. It will be recognized by one skilled in the art that these operations, structural devices, acts and modules may be implemented in software, in firmware, in special purpose digital logic, and/or any combination thereof without deviating from the spirit and scope of the present disclosure as recited within the claims attached hereto.

Information capture block 110 provides communication with a test subject and captures responses to a predetermined set of prompts from the test subject such that those responses may be assessed by an assessor to determine a skill level of the test subject in a particular area, for example, language.

The test subject may utilize a number of methods to request an evaluation and provide responses to the predetermined set of prompts. According to some embodiments, such methods include a phone call over a PSTN line, a cellular call, an Unlicensed Mobile Access (UMA) network call, an Internet telephony call, computer communications (e.g. electronic mail, instant messaging), a facsimile transmission, and the like. Other methods of communication may also be used implementing the principles described herein.

In one embodiment, the predetermined prompts and corresponding responses may be exchanged with processing and storage block 130 over data transfer block 120. In another embodiment, processing block 130 may be in direct communications with information capture block 110. In yet another embodiment, the prompts may be provided by a script executed in the information capture block 110.

Processing and storage block 130 may execute one or more applications selecting appropriate set of prompts based on information received from information capture block 110, recording received responses, assigning a unique identifier to each recorded evaluation session, and the like. The responses may be stored, along with the prompts in some embodiments, in any way known to those skilled in the art. For example, a response in a phone call session may be stored as a voice file with appropriate stops identifying transition to a new prompt/response pair.

In other embodiments, additional information about the session such as ANI information for phone calls, IP address and network information for computer communications may be recorded as part of a Call Detail Record (CDR) along with the responses by processing and storage block 130.

Once the evaluation session is stored, it is available for assessment block 140 to retrieve and perform assessment actions. Assessment block 140 may include interfaces for human assessors such as computing devices, telephone equipment, and the like. The assessors may also include computer programs configured to evaluate voice or other types of responses. In one embodiment, a combination of computer programs and humans assessors may be used to perform the assessment. Data transfer block 120 may also facilitate forwarding of stored evaluation session information to assessment block 140 upon request or another trigger mechanism such as a predetermined schedule.

When the assessment is complete, the result(s) may be stored by processing and storage block 130 or another component of automated skills assessment system 100. The result(s) may include a wide spectrum of information ranging from a simple grade to detailed evaluation of responses.

The stored result(s) may then be retrieved by a results recipient 150 upon request or delivered automatically. The results recipient 150 may be an employer evaluating employee candidates, a school evaluating students, and the like. Automated skills assessment system 100 may also be configured to further interact with the test subject providing feedback, prompting the test subject to submit another evaluation of the same or higher level of difficulty, and the like.

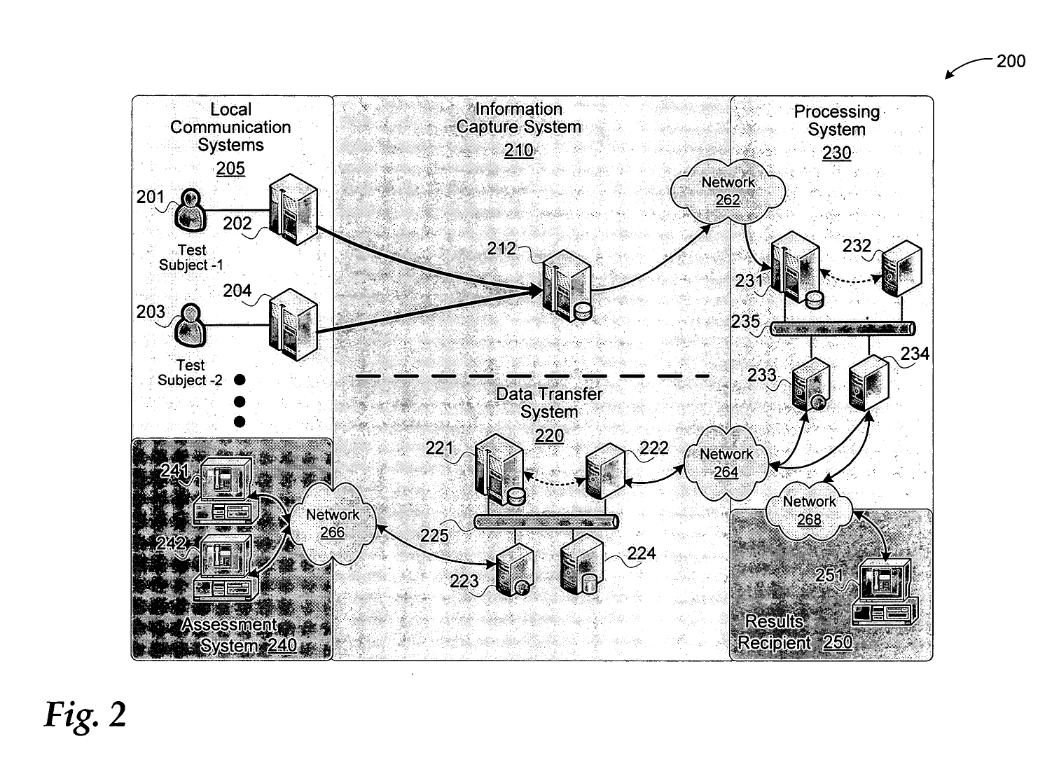

FIG. 2 shows an example automated skills assessment system and interactions of its components. Automated skills assessment system 200 includes local communication systems 205, information capture system 210, data transfer system 220, processing system 230, assessment system 240, and results recipient 250.

Each of the above listed sub-systems may perform actions explained in FIG. 1 individually or in a shared manner. Some or all of the sub-systems may be combined or split into smaller sub-systems. At least a portion of the actions associated with the automated skills assessment may be performed by software applications in each sub-system, while another portion of the actions may be performed by hardware applications. The present invention is not limited to the example software and hardware applications described herein.

Referring now to local communication systems 205, test subjects 201 and 203 may access the automated skills assessment system 200 through a number of communication methods including, but not limited to, calls to a local PBX (e.g. PBX's 202 and 204), cellular calls, accessing a web-based user interface, sending an electronic mail, and the like. The requests from the subjects are consolidated in information capture system 210. The consolidation may include, in one example embodiment, switching IP trunked calls from local PBX's to a SIP. The SIP call is established with processing system 230 over network 262.

Processing system 230 may include a number of specialized servers such as web server 233, SIP-IVR server 231, applications server 232, voice recording server 234, and the like. The servers may communicate with each other and with other sub-systems directly or through a network such as Ethernet 235. Upon receiving the request for evaluation, SIP-IVR server 231 may forward the request to applications server 232, which may execute a script and instruct SIP-IVR server 231 to provide prompts to the test subject (via information capture system 210).

The test subject's responses are recorded for each prompt. In one embodiment, voice recording server 234 may record the responses. In addition to the recorded responses, processing system 230 may also receive additional information in form of a CDR. The CDR may include call origination information, date and time information, test subject identification information, and the like. When the evaluation session is complete, the CDR and the recorded responses may be merged and assigned a unique identifier for subsequent use of the records. The records may be stored in a server in processing system 230 or in a server of data transfer system 220, such as voice storage system 224. While voice recording servers are used as examples, embodiments are not limited to voice-based evaluations. As described before, other forms of communication may also be used to implement automated skills assessment over a network. For other communications forms, such as electronic mail, relevant computing devices and applications to store and provide the evaluation session records may be implemented.

Data transfer system 220 may also include additional servers such as database server 221, communications server 222, web server 223, and the like. Web server 223 of data transfer system 220 may communicate with assessment system 240 over network 266. Data transfer system 220 also communicates with processing system 230 over network 264. Networks 262-268 may include any type of network including, but not limited to, dedicated networks, secure/unsecure networks, and the Internet.

Assessment system 240 may include applications for computerized assessment of evaluation sessions. Assessment system 240 may also include client devices (e.g. client devices 241, 242) for human assessors to receive the evaluation session records and provide results. In yet other embodiments, human assessors may access the system using telephones, facsimile machines, and the like.

Results recipient 250 may include subscribers who access the processing system 230 through network 268.

The computing devices described herein are only examples of a suitable operating environment and are not intended to suggest any limitation as to the scope of use or functionality of the embodiments. Other well known computing systems, environments, and/or configurations that may be suitable for use with the embodiments include, but are not limited to, personal computers, server computers, hand-held or laptop devices, multiprocessor systems, microprocessor-based systems, programmable consumer electronics, network PCs, minicomputers, mainframe computers, distributed computing environments that include any of the above systems or devices, and the like.

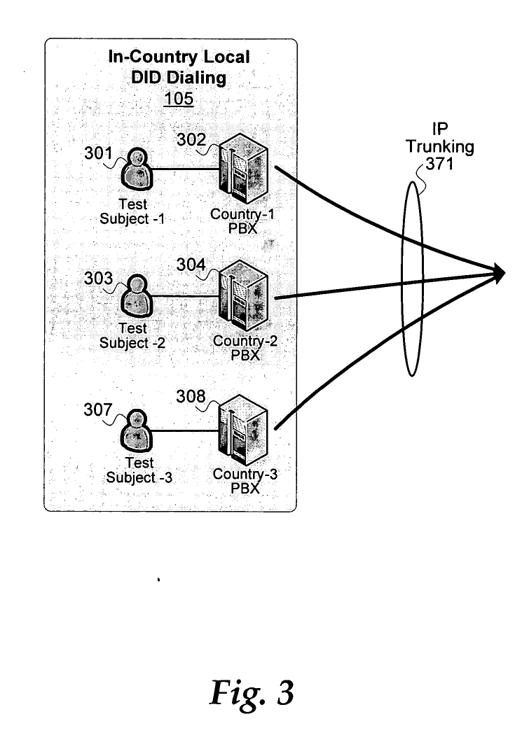

FIGS. 3-6 sequentially depict a conceptual illustration of components of an example automated skills assessment system, in this case a language skills assessment system using calls over a PSTN line to receive responses. The example system is arranged to forward the calls to a central processing system, which executes a script providing prompts to the tests subjects over the same phone line. Responses of the test subjects are recorded and stored, along with CDR information. A data transfer system provides the stored evaluation session information to assessors using an assessment system distributed over different technologies and geographies. Assessment results are stored by the processing system, which also acts as results recipient. The results may then be processed for reporting, analysis, and similar purposes.

Referring now to FIG. 3, an In-Country Local Direct-Inward-Dialing (DID) Dialing system is shown, which is an example of a local communications system component of an automated skills assessment system. In many countries, DID systems provide an easy, local access to information systems for job candidates, and the like. Each test subject (e.g. test subject-1 301, test subject-2 303, test subject-3 307) may call into a DID line of a Private Branch Exchange (PBX) (e.g. PBX 302, 304, 308) in their respective country and request an evaluation session.

When the call is received, certain information such as the ANI number of the caller may be retrieved by the local PBX to determine a location of the call. In some embodiments, local PBX's may perform further actions such as retrieving additional information from a database based on the ANI (e.g. address) and forwarding the information as part of the CDR to the processing system. The local PBX's may forward the calls through IP trunking system 371 to an automated call distribution center outside the respective countries.

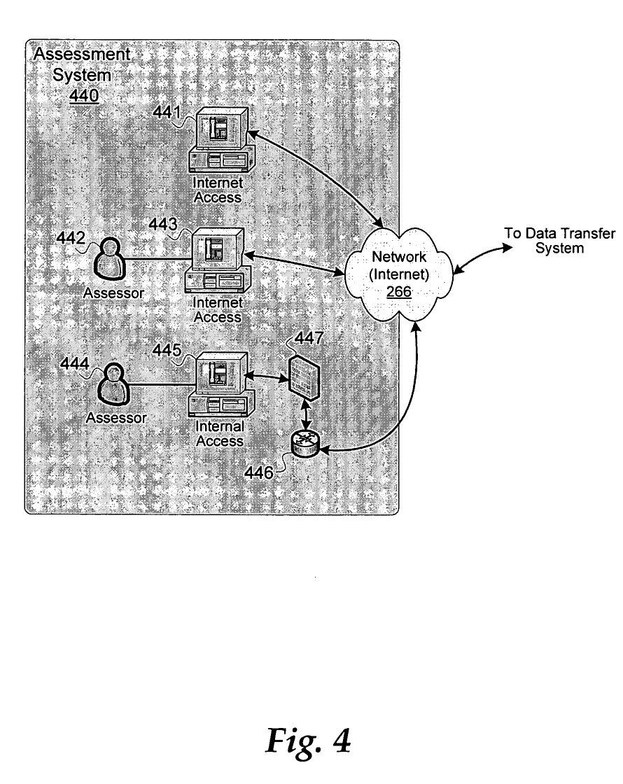

FIG. 4 illustrates assessment system 440 that may be part of the automated skills assessment system of FIG. 1. Assessment system 440 may interact with the data transfer system through network 266 such as the Internet. Assessment system 440 may include a number of assessment methods. For example, assessor 441 is a computer application that is configured to perform the assessment without human intervention. Assessor 441 may include a voice recognition program that recognizes and evaluates particular aspects of the responses such as grammar, pronunciation, and the like. Assessor 441 may communicate with the data transfer system through a secure or unsecure connection over the Internet.

Assessor 442 is a human assessor accessing the assessment system using computing device 443 via the Internet. Computing device 443 may be any of the devices listed herein. In an example embodiment, the stored evaluation session may be provided as a voice file to assessor 442 to listen, assess the responses, and provide a report based on his/her assessment.

Assessor 444 is also a human assessor, who interacts with the assessment system using computing device 445 via a dedicated network (internal access). As part of the dedicated network, computing device 445 may communicate through firewall 447 and router 446 with the server(s) of the data transfer system.

In yet other embodiments, human assessors may access the system by phone, listen to the recorded responses, and provide their assessment in form of keypad entries or voice recordings. Assessors participating assessment system 440 may be in a variety of geographies. They may access the system from stationary locations or remotely using password protected virtual networks, and the like.

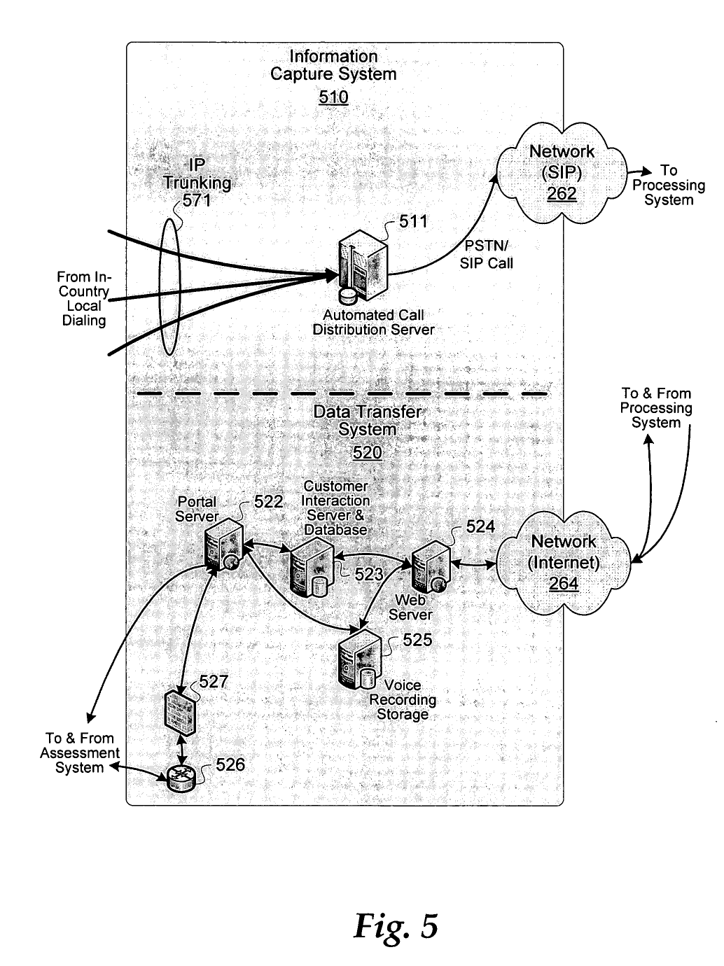

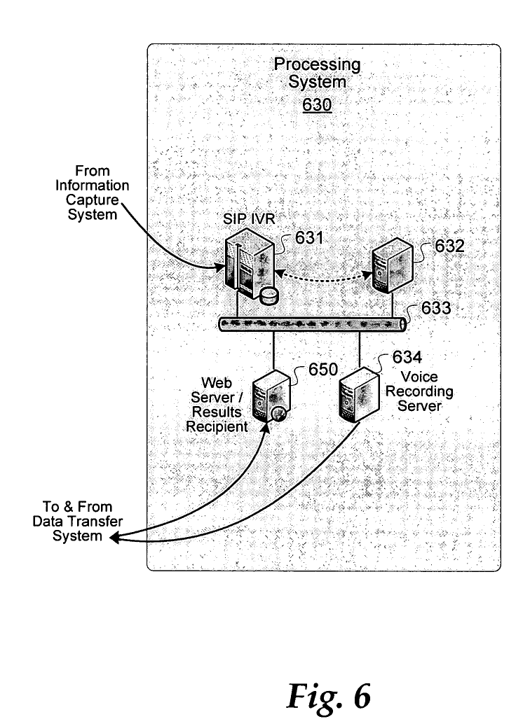

FIG. 5 illustrates an example information capture system and a data transfer system as part of an automated skills assessment system for testing language skills over the phone. In some embodiments, the two systems may be merged into one system or become part of the processing system described below in conjunction with FIG. 6.

Information capture system 510 includes automated call distribution (ADC) server 511. ADC server 511 is configured to receive IP trunked calls from local communications systems such as in-country PBX's. In one embodiment, ADC server 511 converts the IP trunked call to the SIP call and provides to the processing system over a SIP network (network 264). In other embodiments, other types of networking may be utilized to capture the calls from local systems and forward them to a central processing system.

Data transfer system 520 is configured to facilitate communications and data exchange between the assessment system and the processing system. To accomplish this task, data transfer system 520 may include a number of specialized servers and peripherals, or a number of specialized applications running on a single computing device.

In the example embodiment, shown in FIG. 5, data transfer system 520 includes portal server 522 for communication with the assessment system over dedicated networks or the Internet. Web server 524 is configured to facilitate communications with the processing system over the Internet. A customer interaction server and database 523 may be used to manage distribution of assessments, tracking of evaluations, and the like. Moreover, a voice recording storage server 525 may be included in data transfer system 520 to store evaluation and/or assessment records in place of or as a backup to the processing system. The servers or applications performing different tasks in data transfer system 520 may be networked by a number of ways known in the art. Data transfer system 520 may further include firewall 547 and router 526 for communicating with the assessment system over a secure network.

The computing devices and networks described herein are only examples of a suitable operating environment and are not intended to suggest any limitation as to the scope of use or functionality of the embodiments. Other well known computing systems, environments, and/or configurations that may be suitable for use with the embodiments may be implemented using the principles described herein without departing from a scope and spirit of the present invention.

FIG. 6 illustrates an example processing system that interacts with the information capture system shown in FIG. 5. Processing system 630 includes SIP-IVR server 631, applications server 632, web server/results recipient 650, and voice recording server 634, which may interact through a sub-network such as Ethernet 633.

SIP-IVR server 631 is configured to receive the evaluation requesting call from information capture system 510 of FIG. 5 and execute an evaluation script. The script may first prompt the test subject to enter identifying information such as name, address, country, and the like. SIP-IVR server 631 may also receive CDR information to complement the evaluation session record. Part of the information may be provided by DTMF keypad entries, while the responses to the evaluation prompts may be provided in voice. SIP-IVR server 631 may record the responses individually, as a single file, along with prompts, and the like. In some embodiments, SIP-IVR server 631 may perform voice recognition and also store a transcription of the recorded responses.

SIP-IVR server 631 may interact with applications server 632 directly or through Ethernet 633 to provide information, receive instructions such as updates to the evaluation scripts, and the like. Moreover, SIP-IVR server 631 may assign a unique identifier to each stored evaluation session such that the stored file(s) can be accessed and categorized by other programs.

Web server 650 is arranged to act as results recipient in this example embodiment in addition to interacting with the assessment system and providing the stored evaluation session. Web server 650 may receive assessment results from the assessment system to store, analyze, and forward to other recipients. For example, an application on web server 650 may catalog assessment results, send emails to other recipients regarding the results, and even provide financial analysis such as completed assessments to accounting servers that determine payments to assessors.

In one embodiment, SIP-IVR server 631 may provide the completed evaluation session records to voice recording server 634 to be stored. Voice recording server 634 may then make these records available to requesting assessors. Voice recording server 634 may also store assessment results that are recorded in voice files such as phone call assessments from assessors.

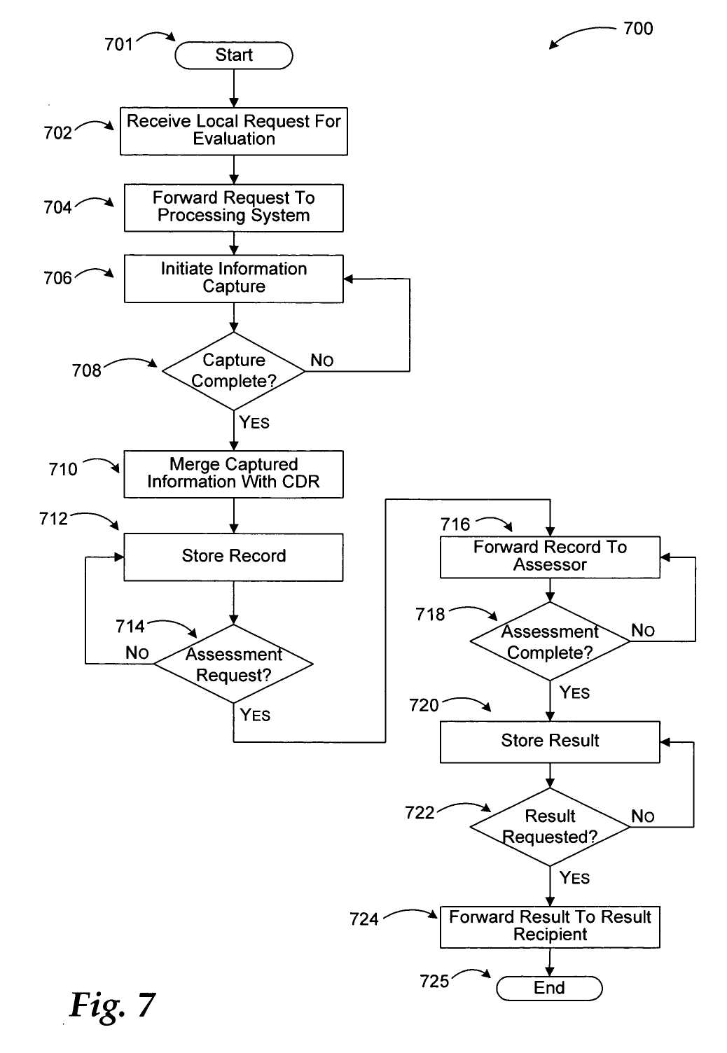

Referring now to FIG. 7, the automated skills assessment process 700 embodies actions practiced by a system as described previously. In accordance with an exemplary embodiment, the operation flow of the automated skills assessment process 700 begins with a start operation 701 and concludes with a terminate operation 725. The start operation 701 is initiated in response to contact being made by a test subject with a local communication component of an automated assessment system. As such, with respect to the exemplary illustration provided herein, the contact may involve a phone call, an electronic mail, an instant message, and the like. From the start operation 701, the operation flow passes to operation 702.

At operation 702, a request for evaluation is received following the contact at start operation 701. In the phone call example, the request for evaluation may be a menu selection by keypad entry or a voice prompt. Processing advances from operation 702 to operation 704.

At operation 704, the request for evaluation is forwarded to the processing system. This may be done by an automated call distribution system. Upon receiving the request for evaluation, the processing system initiates the information capture process in the following operation 706.

The information capture process may include executing a script that provides a series of prompts to the test subject and records corresponding responses. The information capture may further include receiving additional identification information such as an ANI number associated with the request call, an IP address of an electronic mail source, and the like. The operation flow passes to decision operation 708 from operation 706.

At decision operation 708, a determination is made whether the information capture is complete. The information capture may be completed by submitting all prompts to the test subject, or by an early termination request by the test subject. If the information capture is complete, processing moves to operation 710. Otherwise, processing returns to operation 706 for further recording of responses from the test subject.

At operation 710, the captured information is merged with call detail records. The CDR may include the ANI number for PSTN calls, the IP address for electronic mail or instant message, and the like. The CDR may further include information provided by the test subject such as address, name, etc. Time and date of the evaluation session are among additional information that may be included in the CDR. Processing advances from operation 710 to operation 712.

At operation 712, the evaluation session record is stored by the processing system. The processing system may also assign a unique identifier number to the stored record such that it can be easily identified and retrieved for a subsequent assessment process. The operation flow passes from operation 712 to decision operation 714.

At decision operation 714, a determination is made whether an assessment request is received. In some embodiments, the stored evaluation session records may be forwarded to assessors based on an automated schedule, a number of stored records, and similar conditions. In other embodiments, assessors from different geographies may access the automated assessment system and request to receive a record in order to assess the test subject's skills. If an assessment request is received, processing advances to operation 716. Otherwise, processing returns to operation 712 to wait for an assessment request.

At operation 716, the stored evaluation session record is forwarded to the assessor. The assessor may access the system and receive the record in a variety of ways as described previously. The assessor may provide his/her assessment in multiple ways as well. The methods of receiving the stored record and providing the assessment result do not have to be the same. For example, an assessor may call in through a phone line and listen to a recording of the evaluation session. The assessor may then fill out a web-based form to convey his/her assessment of the evaluation. Following operation 716, processing moves to decision operation 718.

At decision operation 718, a determination is made whether the assessment is complete. If the assessment is complete, the operation flow advances to operation 720. Otherwise, the operation flow returns to 718 for further assessment of the evaluation session.

At operation 720, the assessment result is stored by the processing system. In addition to or in place of the processing system, there may be any number of other components of an automated skills assessment system that can store the assessment results. Processing flows from operation 720 to decision operation 722.

At decision operation 722, a determination is made whether the assessment results are requested. As explained previously, the assessment results may be provided to interested parties such as employers, schools, test subjects themselves, and the like, automatically, based on a schedule, or upon request. If the results are requested, the operation flow passes to operation 724 where the results are provided to the recipient. Otherwise processing returns to operation 720.

At operation 724, the results may be provided to the recipient in any way known in the art. The results may also be used for further testing of a test subject such as a higher-level skills assessment upon successful completion of the lower-level evaluation or retaking of the evaluation session upon unsuccessful completion.

The process flow ends at terminate operation 725 where it may advance to a calling process for further actions.

The operations included in process 700 are for illustration purposes. Automated skills testing over a network may be implemented by a similar process with fewer or additional steps, as well as in different order of operations.

Although the embodiments have been described in language specific to structural features, methodological acts, and computer readable media containing such acts, it is to be understood that the embodiments defined in the appended claims are not necessarily limited to the specific structure, acts, or media described. One skilled in the art will recognize other embodiments or improvements that are within the scope and spirit of the present invention.

What is claimed is:

1. A computer-implemented method for automated skills assessment over a network, comprising:
in response to receiving a request to record an evaluation session, initiating an information capture process;
in response to receiving a series of responses to a series of provided prompts, recording the responses;
upon completion of the evaluation session, storing the recorded responses and a call detail record (CDR);
in response to receiving a request to assess the stored responses, providing the recorded responses to an assessor;
in response to receiving an assessment of the stored responses, storing the assessment; and
in response to receiving a request for the assessment, providing the assessment and the associated CDR to an assessment recipient.

2. The computer-implemented method as defined in claim 1, further comprising:
recording the series of prompts along with the corresponding series of responses.

3. The computer-implemented method as defined in claim 1, further comprising:
providing the series of prompts and receiving the series of responses by at least one of: a phone call, an electronic mail, an instant message, a web-based user interface, and a facsimile transmission.

4. The computer-implemented method as defined in claim 3, wherein the phone call is accepted through a local phone line and converted by an automated call distribution center to a digital network exchange.

5. The computer-implemented method as defined in claim 1, further comprising:
assigning a unique identifier to each stored evaluation session and the corresponding assessment.

6. The computer-implemented method as defined in claim 1, wherein the assessment includes at least one of: a voice prompt, a Dual Tone Multi-Frequency (DTMF) key entry, a digital document, and a facsimile transmission.

7. The computer-implemented method as defined in claim 1, further comprising:
receiving a plurality of requests for evaluation from a plurality of locations; and
processing the evaluation sessions and corresponding assessments at a central location.

8. The computer-implemented method as defined in claim 1, further comprising:
prompting an evaluated candidate for a higher level evaluation upon receiving a “successful” assessment for the evaluation session.

9. A system for automated skills assessment over a network, comprising:
a local communication system configured to:
upon receiving a request for recording an evaluation session, interact with a test subject to provide a series of prompts and receive a series of responses associated with the series of prompts;
an information capture system configured to:
forward the series of prompts to the local communication system;
forward the series of responses from the local communication system; and
forward a CDR associated with the evaluation session;
a processing system configured to:
store a record associated with the evaluation session, wherein the record includes at least one of: the series of prompts, the series of responses, and the CDR associated with the evaluation session;
upon receiving a request for assessing the evaluation session, forward the stored record;
upon receiving an assessment of the evaluation session, store the assessment; and
upon receiving a request for the assessment forward the assessment to a subscriber.

10. The system as defined in claim 9, further comprising:
a data transfer system configured to facilitate an exchange of the stored evaluation session and the assessment between the processing system and an assessor.

11. The system as defined in claim 9, wherein the local communication system includes at least one of a PSTN network, a cellular network, an Unlicensed Mobile Access (UMA) network, and a computer network.

12. The system as defined in claim 11, wherein the request for recording the evaluation session is received as one of: a Direct-Inward-Dial (DID) call, a regular phone call, a facsimile transmission, an electronic mail, an instant message, and a text message.

13. The system as defined in claim 9, wherein the information capture system includes an automated call distribution system that is arranged to communicate with the processing system over a Session Initiation Protocol (SIP) network.

14. The system as defined in claim 9, wherein the processing system includes at least one of: an Interactive Voice Recording (IVR) server, a web server, and a storage server.

15. The system as defined in claim 9, wherein the data transfer system includes at least one of: a portal server, a web server, a database server, and a voice recording storage server.

16. The system as defined in claim 9, wherein the information capture system, the processing system, and the data transfer system communicate over at least one of: a dedicated network and the Internet.

17. A computer readable medium having computer-executable instructions for performing a process for automated language skills assessment over a network, the computer process comprising:
in response to receiving a local call requesting to record a language evaluation session, forwarding the call to an interactive voice recording system;
providing a series of prompts soliciting at least one of: a keypad entry response and voice response;
in response to receiving a series of responses to the series of provided prompts, recording the responses;
upon completion of the language evaluation session, storing the recorded responses and a call detail record (CDR);
in response to receiving a request to assess the stored responses, providing the recorded responses to an assessor;
in response to receiving an assessment of the stored responses, storing the assessment; and
in response to receiving a request for the assessment, providing the assessment and the associated CDR to an assessment recipient.

18. The computer readable medium as defined in claim 17, wherein the CDR includes an Automated Number Identification (ANI) identifier associated with the call.

19. The computer readable medium as defined in claim 17, wherein the stored responses are provided to the assessor via at least one of: a PSTN, a cellular network, an Unlicensed Mobile Access UMA network, and a computer network.

20. The computer readable medium as defined in claim 17, wherein the received local call requesting to record the language evaluation session is provided to the interactive voice recording system via a SIP network by an automated call distribution system.
